(19) United States
(12) Patent Application Publication
(10) Pub. No.: US 2024/0129880 A1
(43) Pub. Date: Apr. 18, 2024

(54) Method And Apparatus For Enhancements On Integer Cycle Report For Carrier Phase Positioning

(71) Applicant: MediaTek Singapore Pte. Ltd., Singapore (SG)

(72) Inventors: Xiao Liang, Shanghai (CN); Chiao-Yao Chuang, Hsinchu City (TW); Jijian Chen, Shanghai (CN); Pengli Yang, Shanghai (CN); Xuancheng Zhu, Shanghai (CN)

(21) Appl. No.: 18/373,863

(22) Filed: Sep. 27, 2023

(30) Foreign Application Priority Data
Sep. 30, 2022 (WO) PCT/CN2022/123397
Sep. 22, 2023 (CN) 202311238550.2

(51) Int. Cl. H04W 64/00; H04B 17/336; H04L 5/00

(52) U.S. Cl. CPC H04W 64/00; H04B 17/336; H04L 5/0051

(57) ABSTRACT

Various solutions for enhancements on integer cycle report for carrier phase positioning are described. An apparatus may receive a positioning reference signal (PRS) from a first network node of a wireless network. The apparatus may measure a carrier phase associated with a delay path and a transmission frequency point of the PRS. Then, the apparatus may report the carrier phase to a second network node of the wireless network.

### CROSS REFERENCE TO RELATED PATENT APPLICATION(S)

The present disclosure is part of a non-provisional application claiming the priority benefit of China Patent Application No. 202311238550.2, filed 22 Sep. 2023 based on PCT Application No. PCT/CN2022/123397, filed 30 Sep. 2022. Contents of aforementioned applications are herein incorporated by reference in their entirety.

### TECHNICAL FIELD

The present disclosure is generally related to mobile communications and, more particularly, to enhancements on integer cycle report for carrier phase positioning.

### BACKGROUND

Unless otherwise indicated herein, approaches described in this section are not prior art to the claims listed below and are not admitted as prior art by inclusion in this section.

The timing-based positioning method, such as downlink-time-difference-of-arrival (DL-TDoA), requires the time-of-arrival (ToA) measurement for each base station (BS)-to-user equipment (UE) link. The timing resolution is inversely proportional to the signal bandwidth. To achieve centi-meter accuracy, the concept of carrier phase measurement utilized in global navigation satellite systems (GNSS) can be leveraged to further improve the ToA measurement accuracy for mobile positioning services. In general, carrier phase measurement may include a fraction of a cycle and a number of complete cycles (referred to herein as integer cycle number) measured after the phase is locked. Particularly, the integer cycle number is unknown/unmeasurable initially when the phase lock loop (PLL) gets locked (i.e., when the PRS is received) and remains ambiguous. This problem is also called integer cycle ambiguity and it is the key factor in limiting the performance of carrier phase measurement. Although the integer cycle number can be estimated somehow at a network node, the complexity of an accurate estimation will inevitably increase the burden of the network node.

Accordingly, how to efficiently solve the problem of integer cycle ambiguity has become an important issue in carrier phase positioning. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to integer cycle ambiguity.

In one aspect, a method may involve an apparatus receiving a positioning reference signal (PRS) from a first network node of a wireless network. The method may also involve the apparatus measuring a carrier phase associated with a delay path and a transmission frequency point of the PRS. The method may further involve the apparatus reporting the carrier phase to a second network node of the wireless network.

In one aspect, an apparatus may comprise a transceiver which, during operation, wirelessly communicates with a first network node and a second network node of a wireless network. The apparatus may also comprise a processor communicatively coupled to the transceiver. The processor, during operation, may perform operations comprising receiving, via the transceiver, a PRS from the first network node. The processor may also perform operations comprising measuring a carrier phase associated with a delay path and a transmission frequency point of the PRS. The processor may further perform operations comprising reporting, via the transceiver, the carrier phase to the second network node.

In one aspect, a method may involve a network node receiving a report from an apparatus, wherein the report indicates a carrier phase associated with a delay path and a transmission frequency point of a PRS, an estimate of an integer cycle number of the carrier phase, and a margin error value of the estimated integer cycle number. The method may also involve the network node determining a search range of the integer cycle number based on the estimated integer cycle number and the margin error value. The method may further involve the network node determining the integer cycle number within the search range. The method may further involve the network node performing a carrier phase positioning of the apparatus based on the determined integer cycle number.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (1IoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example of channel impulse response (CIR) observed from the UE in accordance with an implementation of the present disclosure.

FIG. 2 is a diagram depicting an example scenario of integer cycle report for carrier phase positioning in accordance with an implementation of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on integer cycle report for (NR) carrier phase positioning. According to the present disclosure, a number of possible solutions may be implemented separately or jointly. That is, although these possible solutions may be described below separately, two or more of these possible solutions may be implemented in one combination or another.

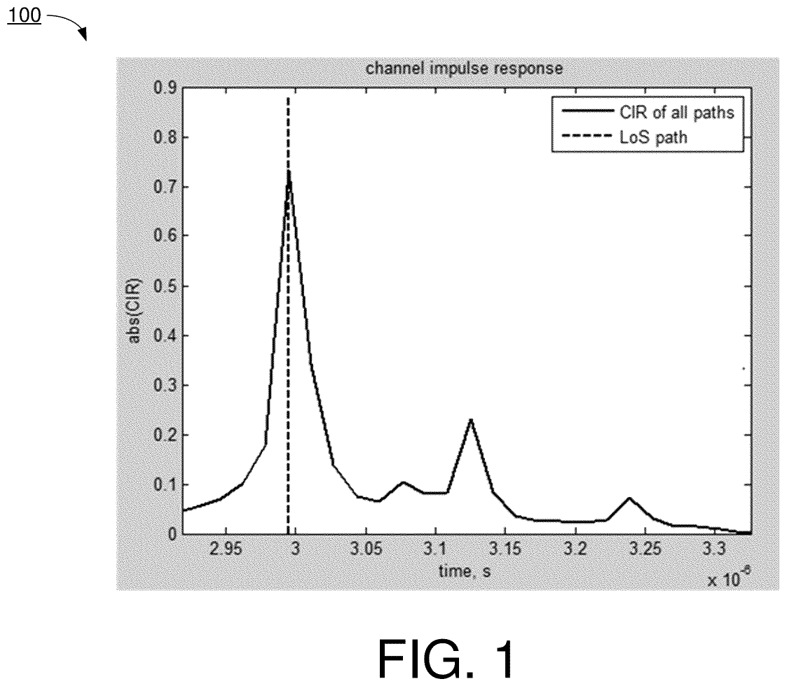

In 3rd Generation Partnership Project (3GPP) Release 16, a new DL reference signal, called PRS, is introduced in technical specification (TS) 38.211 for DL positioning methods, such as DL-TDoA, multi-cell round trip time (Multi-RTT), and downlink-angle-of-departure (DL-AoD), etc. A PRS may be transmitted from a BS to a UE in Nₛ consecutive slots. In each slot, the PRS is provided with a comb structure in time and frequency domain, modulated as an orthogonal frequency-division multiplexing (OFDM) signal. In one example, the PRS of multiple BSs may be interleaved along the different sub-carriers and symbols composing the OFDM signal. When a PRS is transmitted from a BS to a UE, the received signal may suffer from multipath effect caused by the influence of environment. Assuming that the line-of-sight (LoS) path exists, the channel on which the PRS is delivered may also contain multiple reflections with different propagation delays. FIG. 1 illustrates an example diagram 100 of channel impulse response (CIR) observed from the UE in accordance with an implementation of the present disclosure. The propagation delays of the LoS path and other paths are assumed to be quasi-stationary across Nₛ consecutive PRS slots. For the purpose of ranging and positioning, the propagation delay over the LoS path is expected to be estimated as accurately as possible.

In the receiver side, the UE may receive the PRS of multiple BSs. For each BS, the UE may combine all PRS slots/symbols of this BS to estimate the ToA of the PRS. In addition, carrier phase may also be used to estimate the ToA. The carrier phase associated with the LoS path of the PRS is proportional to the ToA and the center frequency of the PRS band, and it is also affected by integer cycle ambiguity. Since carrier phase estimated by the UE is in the range of −π to π, the estimated carrier phase may be formulated as follows:

φ=2π(f_{c}τ+N)

Specifically, f_{c} is the center frequency of the PRS band, N is the unknown integer cycle number (N may be positive or negative), τ is the ToA, φ is the carrier phase measured by the UE.

Note that the integer cycle number affects the estimated ToA a lot. To meet the centi-meter accuracy, the integer cycle number N is expected to be estimated accurately. Estimation of the integer cycle number may be performed by the UE or by the network node (e.g., the location management function (LMF)). In the case where the integer cycle number is estimated in the UE, the estimated result may not be accurate since the UE does not have enough information to derive an accurate estimation. On the other hand, in the case where the integer cycle number is estimated in the LMF, the cost/complexity of the estimation may be too high and the reason is further discussed below.

Considering the resolution of the ToA estimated by the UE is inversely proportional to the signal bandwidth, the residual ToA (denoted as τ_{f}) may be assumed to be within the range from

$$- \frac{1}{2 {f}_{s}} to \frac{1}{2 {f}_{s}} ,$$

where fₛ is the sample rate in the first step, and fₛ is close to the PRS bandwidth. If the integer cycle number is estimated in the LMF and the LMF does not have any information about the search range of integer cycle number N, the search range may be formulated as follows:

$$- \frac{{f}_{c}}{2 {f}_{s}} \leq N \leq \frac{{f}_{c}}{2 {f}_{s}}$$

Specifically, the search range/size of N is

$$\frac{{f}_{c}}{{f}_{s}}$$

for each BS. Now, if there are K carrier phase from K BSs, the total search range/size to be handled by the LMF will be

$${( \frac{{f}_{c}}{{f}_{s}} )}^{K} .$$

As such, since f_{c}>>fₛ, the total search range/size will be too large for the LMF to derive an accurate estimation of the integer cycle number.

In view of the above, the present disclosure proposes a number of schemes pertaining to enhancements on integer cycle report for carrier phase positioning. According to some schemes of the present disclosure, a UE may measure the carrier phase associated with a delay path (e.g., the LoS path) and a transmission frequency point of the PRS, and for the carrier phase of each BS k, determine an estimate of an integer cycle number with a margin error value (i.e., the estimated integer cycle number may not be accurate enough and may have some unknown uncertainty). Furthermore, the UE may report the carrier phase, the estimated integer cycle number, and the margin error value (also called “uncertainty”) to the network node (e.g., LMF), such that the search of accurate integer cycle number can be narrowed down to the range between [symbol] −Nₖ^{u} and [symbol] +Nₖ^{u}. Accordingly, by applying the schemes of the present disclosure, the complexity for the network node to solve the integer cycle ambiguity can be significantly reduced, so as to improve the performance of carrier phase positioning.

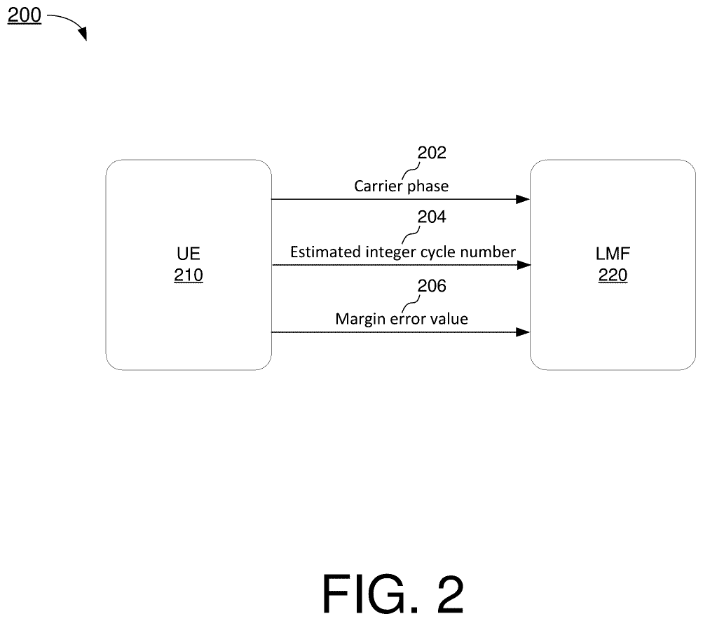

FIG. 2 illustrates an example scenario 200 of integer cycle report for carrier phase positioning in accordance with an implementation of the present disclosure. Scenario 200 depicts a communication mechanism between a UE 210 and an LMF 220. The communication mechanism may include reporting a plurality of parameters by the UE 210 to the LMF 220. In detail, the reporting of the parameters may include one or more operations, actions, or functions as illustrated by one or more of steps 202 to 206. Although illustrated as discrete steps, the reporting of the parameters may be combined into one or fewer steps, depending on the desired implementation.

At 202, the UE 210 may measure and report the carrier phase (of each BS k) associated with a delay path (e.g., the LoS path) and a transmission frequency point of a received PRS to the LMF 220. In one example, the measuring of the carrier phase may be performed by using a double difference method to cancel the initial phase mismatch. Specifically, the double difference method contains four phases to achieve the cancellation. The first phase is measured from the observation of the signal transmitted by TX a to RX 1, which may be formulated as follows in equation (1):

$$( {f}_{a} - {f}_{c} ) * {t}_{{RX}_{1}^{′}} - {f}_{a} * ( {t}_{{RX}_{1}^{a}} - {t}_{{TX}^{a}} ) + {∅}_{{TX}^{a}} ( 0 ) - {ψ}_{{RX}_{1}} ( 0 ) + ( a perturbed term due to CFO )$$

Specifically, fₐ is the RF frequency of the signal, and

$${t}_{{RX}_{1}^{a}} - {t}_{{TX}^{a}}$$

is the propagation time. The second phase is measured from the observation of the signal transmitted by TX a to RX 2, which may be formulated as follows:

$$( {f}_{a} - {f}_{c} ) * {t}_{{RX}_{2}^{′}} - {f}_{a} * ( {t}_{{RX}_{2}^{a}} - {t}_{{TX}^{a}} ) + {∅}_{{TX}^{a}} ( 0 ) - {ψ}_{{RX}_{2}} ( 0 ) + ( a perturbed term due to CFO )$$

The third phase is measured from the observation of the signal transmitted by TX b to RX 1, which may be formulated as follows:

$$( {f}_{a} - {f}_{c} ) * {t}_{{RX}_{1}^{′}} - {f}_{a} * ( {t}_{{RX}_{1}^{b}} - {t}_{{TX}^{b}} ) + {∅}_{{TX}^{b}} ( 0 ) - {ψ}_{{RX}_{1}} ( 0 ) + ( a perturbed term due to CFO )$$

The fourth phase is measured from the observation of the signal transmitted by TX b to RX 2, which may be formulated as follows:

$$( {f}_{a} - {f}_{c} ) * {t}_{{RX}_{2}^{′}} - {f}_{a} * ( {t}_{{RX}_{2}^{b}} - {t}_{{TX}^{b}} ) + {∅}_{{TX}^{b}} ( 0 ) - {ψ}_{{RX}_{2}} ( 0 ) + ( a perturbed term due to CFO )$$

The difference between the first phase and the second phase, as well as the difference between the third phase and the fourth phase, may be referred to as a single difference, and the difference between these two single differences may be referred to as a double difference. As such, the double difference may be formulated as two carrier phase measurements as follows:

(first phase−second phase)−(third phase−fourth phase)=(first phase−third phase)−(second phase−fourth phase)

These two carrier phase measurements are based on the signal from two different TRPs, but these two carrier phase measurements correspond to the same transmission frequency point. Accordingly, after performing the double difference method at the UE side, the initial phase mismatch may be canceled.

At 204, the UE 210 may determine and report the estimated (also called “coarse”) integer cycle number of the carrier phase to the LMF 220. The estimated integer cycle number may be used as the ToA measurement. Specifically, the UE 210 may use the brute force method to determine the estimated integer cycle number. In the case where the received PRS is a multi-carrier PRS, the UE 210 may determine the estimated integer cycle number based on the multi-carrier PRS.

At 206, the UE 210 may determine and report the margin error value (also called “uncertainty”) of the estimated integer cycle number to the LMF 220. Specifically, the UE 210 may determine the margin error value based on the scenario (e.g., indoor scenario, such as indoor office or indoor factory, or outdoor scenario) or other information of each BS, such as the signal-to-noise ratio (SNR), and doppler frequency, etc.

### Illustrative Implementations

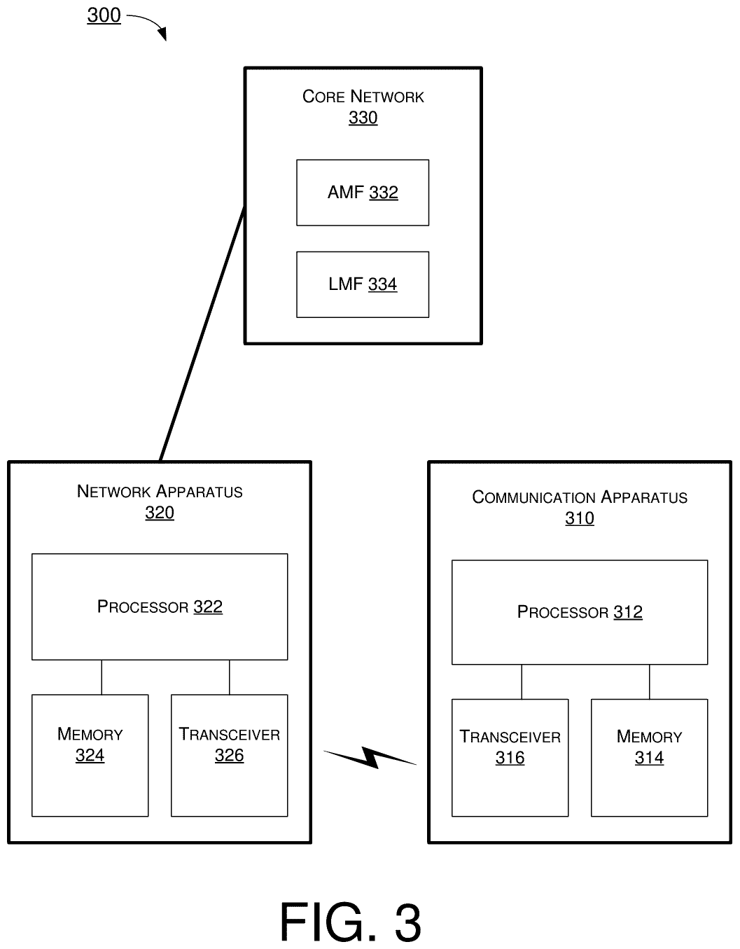

FIG. 3 illustrates an example communication system 300 having an example communication apparatus 310, an example network apparatus 320, and an example core network 330 in accordance with an implementation of the present disclosure. Each of communication apparatus 310, network apparatus 320, and core network 330 may perform various functions to implement schemes, techniques, processes and methods described herein pertaining to enhancements on integer cycle report for carrier phase positioning, including scenarios/schemes described above as well as processes 400 and 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router, a gateway, or an LMF. For instance, network apparatus 320 may be implemented in an eNodeB in an LTE, LTE-Advanced or LTE-Advanced Pro network, or in a gNB or a transmission and reception point (TRP) in a 5G NR, IoT, NB-IoT, or IIoT network, or in a satellite or a BS in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including enhancements on integer cycle report for carrier phase positioning in a device (e.g., as represented by communication apparatus 310) and a network node (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, network apparatus 320 may also include a transceiver 326 coupled to processor 322 and capable of wirelessly transmitting and receiving data. In some implementations, transceiver 326 may be capable of wirelessly communicating with different types of UEs of different RATs. In some implementations, transceiver 326 may be equipped with a plurality of antenna ports (not shown) such as, for example, four antenna ports. That is, transceiver 326 may be equipped with multiple transmit antennas and multiple receive antennas for MI MO wireless communications.

In some implementations, communication apparatus 310 may further include a memory 314 coupled to processor 312 and capable of being accessed by processor 312 and storing data therein. In some implementations, network apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Core network 330 may include at least some of those functions, entities, or nodes shown in FIG. 3 such as an access and mobility management function (AMF) 332 and an LMF 334. Communication between communication apparatus 310 and core network 330 may be realized through network apparatus 320. Although not shown in FIG. 3, each of AMF 332 and LMF 334 may include at least a processor (e.g., similar to processor 312/322), a transceiver (e.g., similar to transceiver 316/326 but provides wired communication instead), and a memory (e.g., similar to memory 314/324), to implement schemes, techniques, processes and methods described herein pertaining to enhancements on integer cycle report for carrier phase positioning. Network apparatus 320 may further include one or more other components or entities not pertinent to the proposed schemes of the present disclosure (e.g., Unified Data Management (UDM), The Gateway Mobile Location Centre (GMLC), SUPL (Secure User Plane Location) Location Platform (SLP), etc.), such function(s) of core network 330 are neither shown in FIG. 3 nor described below in the interest of simplicity and brevity. Core network 330 may be implemented in or as core network of telecom operator or server of third party (e.g., location services (LCS) server, but not limited thereto).

Each of communication apparatus 310, network apparatus 320, and LMF 334 of core network 330 may be a communication entity capable of communicating with each other using various proposed schemes in accordance with the present disclosure. For illustrative purposes and without limitation, a description of operations, functionalities, and capabilities of communication apparatus 310, as a UE, network apparatus 320, as a network node (e.g., a BS), and LMF 334, as another network node, is provided below.

Under various proposed schemes in accordance with the present disclosure with respect to enhancements on integer cycle report for carrier phase positioning, processor 312 of communication apparatus 310, implemented in or as a UE, may receive, via transceiver 316, a PRS from network apparatus 320. Then, processor 312 may measure a carrier phase associated with a delay path (e.g., the LoS path) and a transmission frequency point of the PRS. Then, processor 312 may report, via transceiver 316, the carrier phase to LMF 334 of core network 330.

In some implementations, the measuring of the carrier phase may include determining a difference of two carrier phase measurements that are based on a signal from different TRPs and corresponding to the same transmission frequency point.

In some implementations, the transmission frequency point may be the carrier frequency of a carrier at radio frequency.

In some implementations, the transmission frequency point may be configured by the wireless network.

In some implementations, processor 312 may also determine an estimate of an integer cycle number of the carrier phase and a margin error value of the estimated integer cycle number. Then, processor 312 may further report, via transceiver 316, the estimated integer cycle number and the margin error value to LMF 334 of core network 330.

In some implementations, the determining of the estimate of the integer cycle number may be performed by using a brute force method.

In some implementations, the PRS may include a multi-carrier PRS, and the determining of the estimate of the integer cycle number may be performed based on the multi-carrier PRS.

In some implementations, the determining of the margin error value of the estimated integer cycle number may be performed based on at least one of the following: (1) an SNR measured from the first network node; (2) a doppler frequency measured from the first network node; and (3) a measured quality of the estimated timing (e.g., quality can be defined as confidence of the estimated timing).

Correspondingly, under various proposed schemes in accordance with the present disclosure, a processor of LMF 334, may receive (e.g., via network apparatus 320) a report from communication apparatus 310. The report may indicate a carrier phase associated with a delay path (e.g., LoS path) and a transmission frequency point of a PRS, an estimate of an integer cycle number of the carrier phase, and a margin error value of the estimated integer cycle number. Then, the processor of LMF 334 may determine a search range of the integer cycle number based on the estimated integer cycle number and the margin error value. Moreover, the processor of LMF 334 may determine the integer cycle number within the search range. After that, the processor of LMF 334 may perform a carrier phase positioning of communication apparatus 310 based on the determined integer cycle number.

In some implementations, the determining of the integer cycle number may be performed only within the search range.

In some implementations, the PRS may be transmitted to communication apparatus 310 on more than one component carrier (CC).

### Illustrative Processes

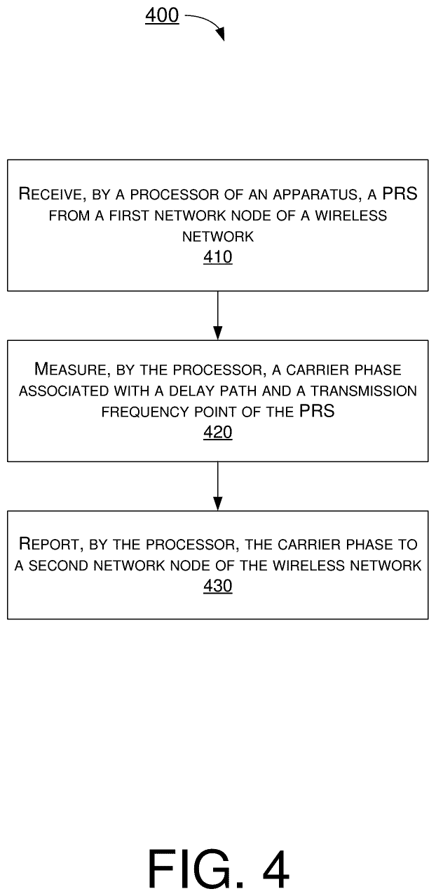

FIG. 4 illustrates an example process 400 in accordance with an implementation of the present disclosure. Process 400 may be an example implementation of above scenarios/schemes, whether partially or completely, with respect to enhancements on integer cycle report for carrier phase positioning. Process 400 may represent an aspect of implementation of features of communication apparatus 310. Process 400 may include one or more operations, actions, or functions as illustrated by one or more of blocks 410 to 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310) receiving, via transceiver 316, a PRS from network apparatus 320. Process 400 may proceed from 410 to 420.

At 420, process 400 may involve processor 312 measuring a carrier phase associated with a delay path (e.g., the LoS path) and a transmission frequency point of the PRS. Process 400 may proceed from 420 to 430.

At 430, process 400 may involve processor 312 reporting, via transceiver 316, the carrier phase to LMF 334 of core network 330.

In some implementations, the measuring of the carrier phase may include determining a difference of two carrier phase measurements that are based on a signal from different TRPs and corresponding to the same transmission frequency point.

In some implementations, the transmission frequency point may be the carrier frequency of a carrier at radio frequency.

In some implementations, the transmission frequency point may be configured by the wireless network.

In some implementations, process 400 may further involve processor 312 determining an estimate of an integer cycle number of the carrier phase and a margin error value of the estimated integer cycle number, and reporting, via transceiver 316, the estimated integer cycle number and the margin error value to LMF 334 of core network 330.

In some implementations, the determining of the estimate of the integer cycle number may be performed by using a brute force method.

In some implementations, the PRS may include a multi-carrier PRS, and the determining of the estimate of the integer cycle number is performed based on the multi-carrier PRS.

In some implementations, the determining of the margin error value of the estimated integer cycle number may be performed based on at least one of the following: (1) an SNR measured from the first network node; (2) a doppler frequency measured from the first network node; and (3) a measured quality of the estimated timing.

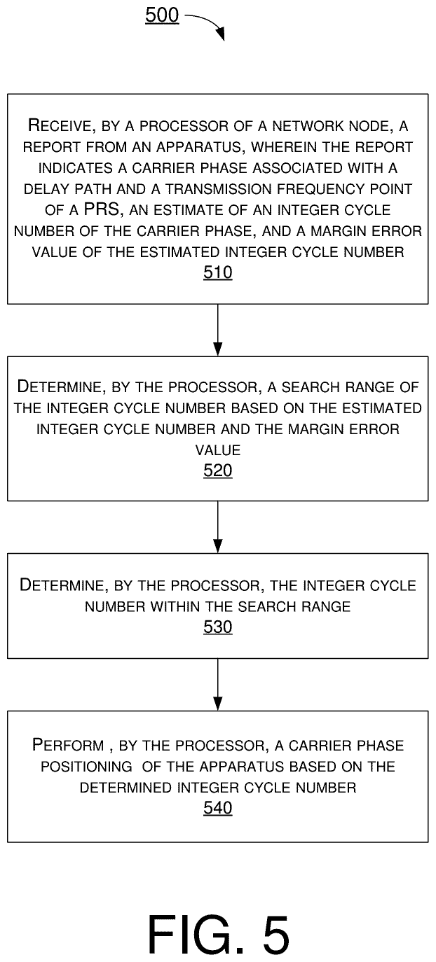

FIG. 5 illustrates an example process 500 in accordance with an implementation of the present disclosure. Process 500 may be an example implementation of above scenarios/schemes, whether partially or completely, with respect to enhancements on integer cycle report for carrier phase positioning. Process 500 may represent an aspect of implementation of features of LMF 334 of core network 330. Process 500 may include one or more operations, actions, or functions as illustrated by one or more of blocks 510 to 540. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by LMF 334 or any suitable network node/function/entity. Solely for illustrative purposes and without limitation, process 500 is described below in the context of LMF 334. Process 500 may begin at block 510.

At 510, process 500 may involve a processor of LMF 334 receiving a report from communication apparatus 310. The report may indicate a carrier phase associated with a delay path (e.g., the LoS path) and a transmission frequency point of a PRS, an estimate of an integer cycle number of the carrier phase, and a margin error value of the estimated integer cycle number. Process 500 may proceed from 510 to 520.

At 520, process 500 may involve the processor of LMF 334 determining a search range of the integer cycle number based on the estimated integer cycle number and the margin error value. Process 500 may proceed from 520 to 530.

At 530, process 500 may involve the processor of LMF 334 determining the integer cycle number within the search range. Process 500 may proceed from 530 to 540.

At 540, process 500 may involve the processor of LMF 334 performing a carrier phase positioning of communication apparatus 310 based on the determined integer cycle number.

In some implementations, the determining of the integer cycle number may be performed only within the search range.

In some implementations, the PRS is transmitted to communication apparatus 310 on more than one CC.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a positioning reference signal (PRS) from a first network node of a wireless network;
measuring, by the processor, a carrier phase associated with a delay path and a transmission frequency point of the PRS; and
reporting, by the processor, the carrier phase to a second network node of the wireless network.

2. The method of claim 1, wherein the measuring of the carrier phase comprises determining a difference of two carrier phase measurements that are based on a signal from different transmission or reception points (TRPs) and corresponding to the same transmission frequency point.

3. The method of claim 1, wherein the transmission frequency point is the carrier frequency of a carrier at radio frequency, or the transmission frequency point is configured by the wireless network.

4. The method of claim 1, further comprising:
determining, by the processor, an estimate of an integer cycle number of the carrier phase and a margin error value of the estimated integer cycle number; and
reporting, by the processor, the estimated integer cycle number and the margin error value to the second network node of the wireless network.

5. The method of claim 4, wherein the determining of the estimate of the integer cycle number is performed by using a brute force method.

6. The method of claim 4, wherein the PRS comprises a multi-carrier PRS, and the determining of the estimate of the integer cycle number is performed based on the multi-carrier PRS.

7. The method of claim 4, wherein the determining of the margin error value of the estimated integer cycle number is performed based on at least one of:
a signal-to-noise ratio (SNR) measured from the first network node;
a doppler frequency measured from the first network node; and
a measured quality of an estimated timing.

8. The method of claim 1, wherein the first network node comprises a base station, and the second network node comprises a location management function (LMF).

9. An apparatus, comprising:
a transceiver which, during operation, wirelessly communicates with a first network node and a second network node of a wireless network; and
a processor communicatively coupled to the transceiver such that, during operation, the processor performs operations comprising:
receiving, via the transceiver, a positioning reference signal (PRS) from the first network node;
measuring a carrier phase associated with a delay path and a transmission frequency point of the PRS; and
reporting, via the transceiver, the carrier phase to the second network node.

10. The apparatus of claim 9, wherein the measuring of the carrier phase comprises determining a difference of two carrier phase measurements that are based on a signal from different transmission or reception points (TRPs) and corresponding to the same transmission frequency point.

11. The apparatus of claim 9, wherein the transmission frequency point is the carrier frequency of a carrier at radio frequency, or the transmission frequency point is configured by the wireless network.

12. The apparatus of claim 9, wherein, during operation, the processor further performs operations comprising:
determining an estimate of an integer cycle number of the carrier phase and a margin error value of the estimated integer cycle number; and
reporting, via the transceiver, the estimated integer cycle number and the margin error value to the second network node.

13. The apparatus of claim 12, wherein the determining of the estimate of the integer cycle number is performed by using a brute force method.

14. The apparatus of claim 12, wherein the PRS comprises a multi-carrier PRS, and the determining of the estimate of the integer cycle number is performed based on the multi-carrier PRS.

15. The apparatus of claim 12, wherein the determining of the margin error value of the estimated integer cycle number is performed based on at least one of:
a signal-to-noise ratio (SNR) measured from the first network node;
a doppler frequency measured from the first network node; and
a measured quality of an estimated timing.

16. The apparatus of claim 9, wherein the first network node comprises a base station, and the second network node comprises a location management function (LMF).

17. A method, comprising:
receiving, by a processor of a network node, a report from an apparatus, wherein the report indicates a carrier phase associated with a delay path and a transmission frequency point of a positioning reference signal (PRS), an estimate of an integer cycle number of the carrier phase, and a margin error value of the estimated integer cycle number;
determining, by the processor, a search range of the integer cycle number based on the estimated integer cycle number and the margin error value;
determining, by the processor, the integer cycle number within the search range; and
performing, by the processor, a carrier phase positioning of the apparatus based on the determined integer cycle number.

18. The method of claim 17, wherein the determining of the integer cycle number is performed only within the search range.

19. The method of claim 17, wherein the PRS is transmitted to the apparatus on more than one component carrier (CC).

20. The method of claim 17, wherein the network node comprises a location management function (LMF).
